(19) United States
(12) Patent Application Publication
(10) Pub. No.: US 2013/0250180 A1
(43) Pub. Date: Sep. 26, 2013

(54) HDMI SIGNAL DISTRIBUTOR

(71) Applicant: Cheng-Si WANG, Changhua Hsien (TW)

(72) Inventor: Cheng-Si WANG, Changhua Hsien (TW)

(21) Appl. No.: 13/426,229

(22) Filed: Mar. 21, 2012

(51) Int. Cl. H04N 7/015

(52) U.S. Cl. 348/720; 348/E07.004

(57) ABSTRACT

An HDMI signal distributor includes a distributing unit, an HDMI source port, multiple HDMI objective ports and a detector. The distributing unit includes an input port, multiple output ports and multiple control pins. The HDMI source port is connected to the distributing unit and includes a DDC pin set and multiple data pins. The multiple HDMI objective ports are connected to the distributing unit and each HDMI objective port includes a DDC pin set and multiple data pins. The detector is connected to the distributing unit, the HDMI source port and the multiple HDMI objective ports. The detector includes multiple duplex-connecting ports, multiple control pins and an EDID determining module. The EDID determining module compares an EDID signal from each HDMI objective port with an EDID signal from the HDMI source port to send suitable signals to the HDMI objective ports.

### BACKGROUND OF THE INVENTION

1. Field of the Invention

The present invention relates to a signal distributor, and more particularly to an HDMI signal distributor.

2. Description of Related Art

High definition multimedia interface (HDMI) is a full digital video and audio interface and is suitable for satellite signal receivers, Blu-ray Disc players, computers and TVs. The connections among the various equipments can be simplified to one single HDMI cable to transmit uncompressed and high-quality video and audio signals. A standard HDMI interface has nineteen pins including the pins for transmitting data and clock signals and a display data channel (DDC) pin set for transmitting signals between two connected equipments.

An extended display identification data (EDID) of the HDMI interface protocol is provided for gaining information from a monitor via DDC pin set. Therefore, a signal source, such as the Blu-ray Disc player or the satellite signal receiver, can gain the TV displaying requirements and abilities via the EDID of the DDC pin set, and transmit a corresponding video signal to the TV. While the TV provides a display resolution of 480p, the Blu-ray Disc player will only transmit video signals of 480p without transmitting high quantity signals of 1080p. The video signals will not over-range the displaying ability of the TV.

The transmission of the HDMI signal is a kind of point to point protocol, which means a signal source corresponds to a monitor and transmits a video signal to the monitor. When the HDMI signal is distributed to multiple monitors, a conventional distributor is connected to the monitors and distributes the HDMI signal to the monitors. For instance, the conventional distributor has an input port and eight output ports to be connected to the eight monitors. If the monitors have different displaying abilities, the conventional distributor usually takes a first one of the monitors to be a displaying standard and the other monitors follow the standard for displaying. However, if the first one of the monitors has a displaying ability higher than those of the other monitors, the other monitors may not output the HDMI signals as high as the first one of the monitors. For example, eight TVs are arranged as a TV wall. One of the eight TVs is able to display 1080p signals of 12 bits and the others of the eight TVs may display 1080p signals of 8 bits. If the Blu-ray Disc player outputs 1080p signals of 12 bits to all of the TVs, only one TV can display the 1080p signals of 12 bits.

To solve the above defeat, a conventional method is to compare the EDID information of all monitors with one another and choose a lowest displaying ability among them as a standard to ensure that every TV outputs video signals. However, the TV that has higher displaying ability will be sacrificed and will not provide the higher displaying ability.

To overcome the shortcomings, the present invention tends to provide an HDMI signal distributor to mitigate or obviate the aforementioned problems.

### SUMMARY OF THE INVENTION

The main objective of the invention is to provide an HDMI signal distributor that includes a distributing unit, an HDMI source port, multiple HDMI objective ports and a detector.

The distributing unit includes an input port, multiple output ports and multiple control pins. The input port of the distributing unit has a display data channel (DDC) pin set, which includes a serial clock input (SCL) pin and a serial data (SDA) pin. Each output port of the distributing unit has a DDC pin set including an SCL pin and an SDA pin. The HDMI source port is capable of connecting to a signal source, is connected to the distributing unit and includes a DDC pin set and multiple data pins. The DDC pin set of the HDMI source port includes an SCL pin and an SDA pin. The multiple data pins of the HDMI source port are electrically connected to the input ports of the distributing unit. The multiple HDMI objective ports are connected to the distributing unit. Each HDMI objective port is capable of connecting to a monitor and includes a DDC pin set and multiple data pins. The DDC pin set of each HDMI objective port includes an SCL pin and an SDA pin. The multiple data pins of each HDMI objective port are respectively and electrically connected to a corresponding one of the output ports of the distributing unit. The detector is connected to the distributing unit, the HDMI source port and the multiple HDMI out ports. The detector includes multiple duplex-connecting ports, multiple control pins and an extended display identification data (EDID) determining module. The multiple duplex-connecting ports are respectively and electrically connected to the DDC pin sets of the distributing unit, the HDMI source port and the HDMI objective ports. The multiple control pins are respectively connected to the multiple control pins of the distributing unit. The EDID determining module compares an EDID signal from each HDMI objective port with an EDID signal from the HDMI source port. The EDID determining module is controlled to choose a mixed (MIX) mode or an efficiency gained with economy (ECO) mode. The EDID determining module chooses a lowest displaying ability from all of the EDID signals in the MIX mode and sends the control signal based on the lowest displaying ability to the multiple HDMI objective ports. The EDID determining module chooses a displaying ability from the EDID signal of a first one of the multiple HDMI objective ports in the ECO mode and sends the control signal based on the displaying ability to the multiple HDMI objective ports. The multiple HDMI objective ports are connected to the detector via a multiplexer/demultiplexer, such that the DDC pin set of the detector obtains signals of the DDC pin set of the multiple HDMI objective ports from the multiplexer/demultiplexer.

Other objects, advantages and novel features of the invention will become more apparent from the following detailed description when taken in conjunction with the accompanying drawings.

### BRIEF DESCRIPTION OF THE DRAWINGS

FIG. 1 is a block diagram of an HDMI distributor in accordance with the present invention;

FIGS. 2A, 2B, 2C, 2D, 2E and 2F are circuit diagrams of a detector of the HDMI distributor in accordance with the present invention;

FIGS. 3A, 3B, 3C and 3D are circuit diagrams of a distributing unit of the HDMI distributor in accordance with present invention;

FIG. 3E is a circuit diagram of an HDMI source port of the HDMI distributor in accordance with the present invention;

FIGS. 4A and 4B are circuit diagrams of a first HDMI objective port of the HDMI distributor in accordance with the present invention;

FIGS. 4C and 4D are circuit diagrams of a second HDMI objective port of the HDMI distributor in accordance with the present invention; and

FIG. 4E is a circuit diagram of a multiplexer/demultiplexer which is connected between the first HDMI objective port and the detector and is connected between the second HDMI objective port and the detector in accordance with the present invention.

### DETAILED DESCRIPTION OF PREFERRED EMBODIMENT

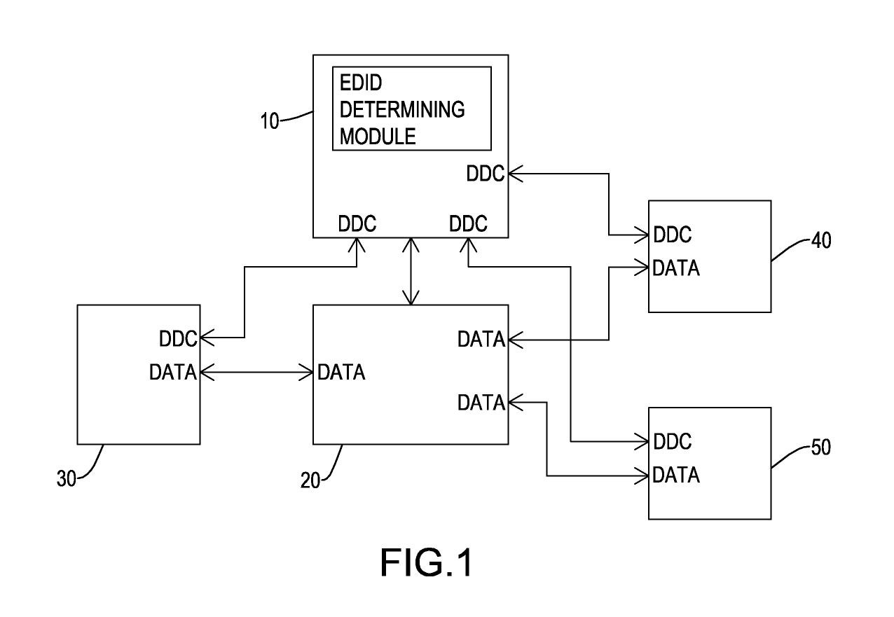

With reference to FIG. 1, a high definition multimedia interface (HDMI) distributor in accordance with the present invention comprises a detector 10, a distributing unit 20, an HDMI source port 30 and multiple HDMI objective ports.

Preferably, the multiple HDMI objective ports include a first HDMI objective port 40 and a second HDMI objective port 50. The detector 10 is electrically connected to the distributing unit 20 and the HDMI source port 30. Each of the first and second HDMI objective ports 40, 50 is electrically connected to the detector 10 and the distributing unit 20.

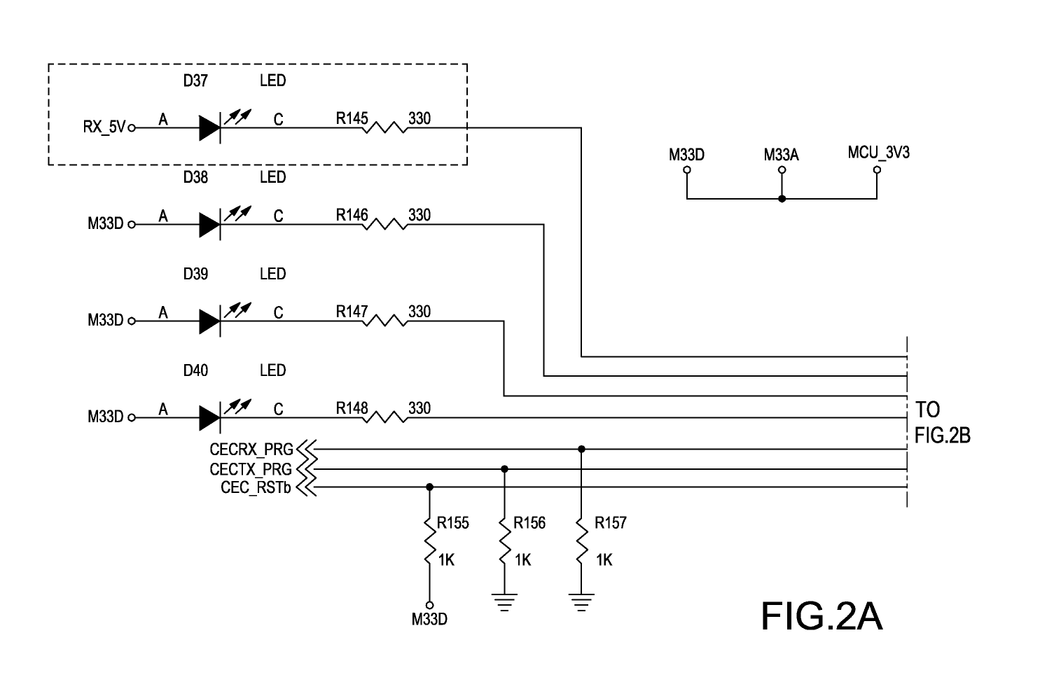

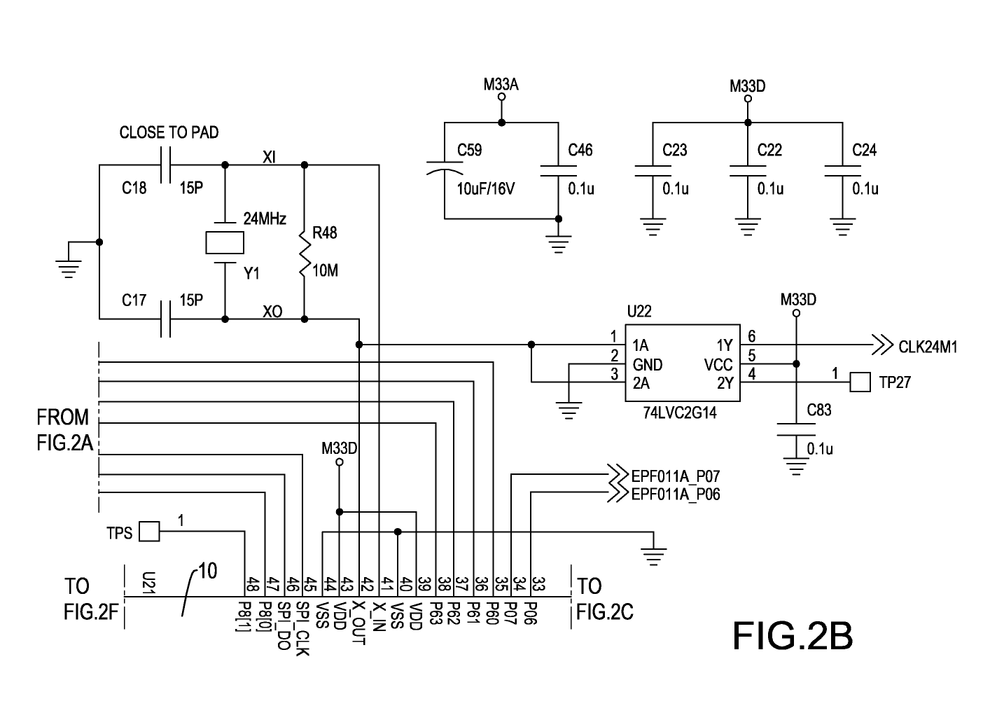

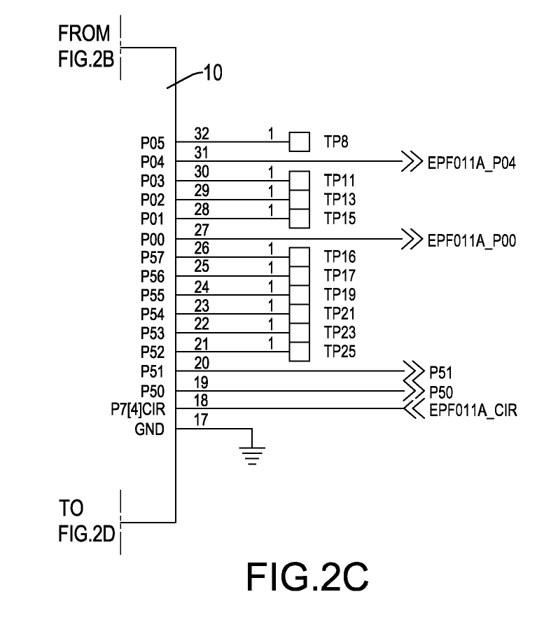

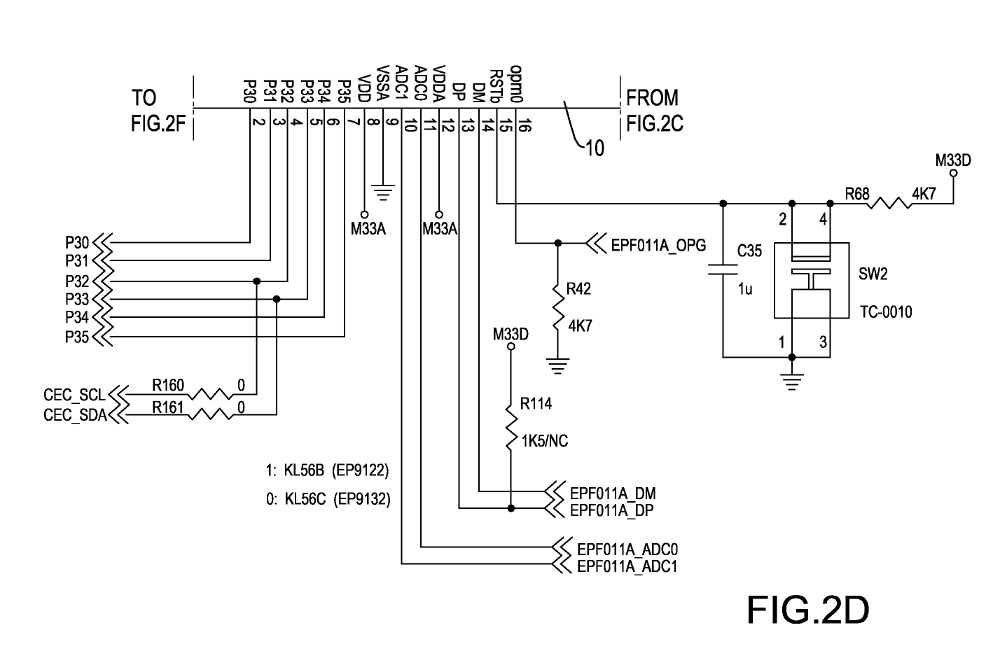

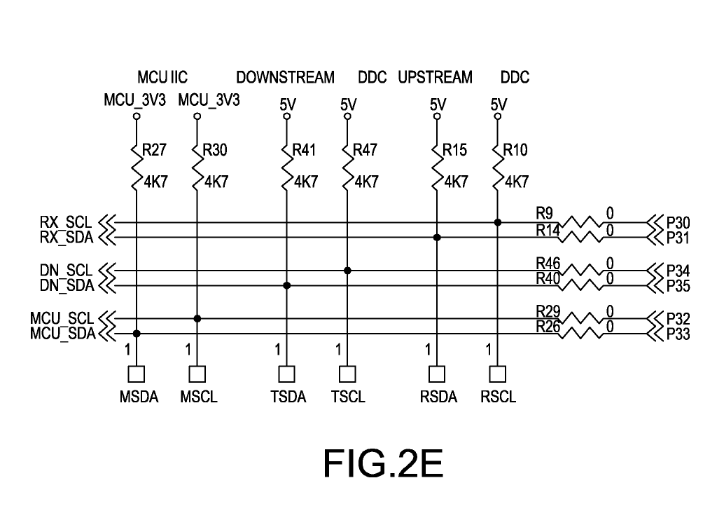

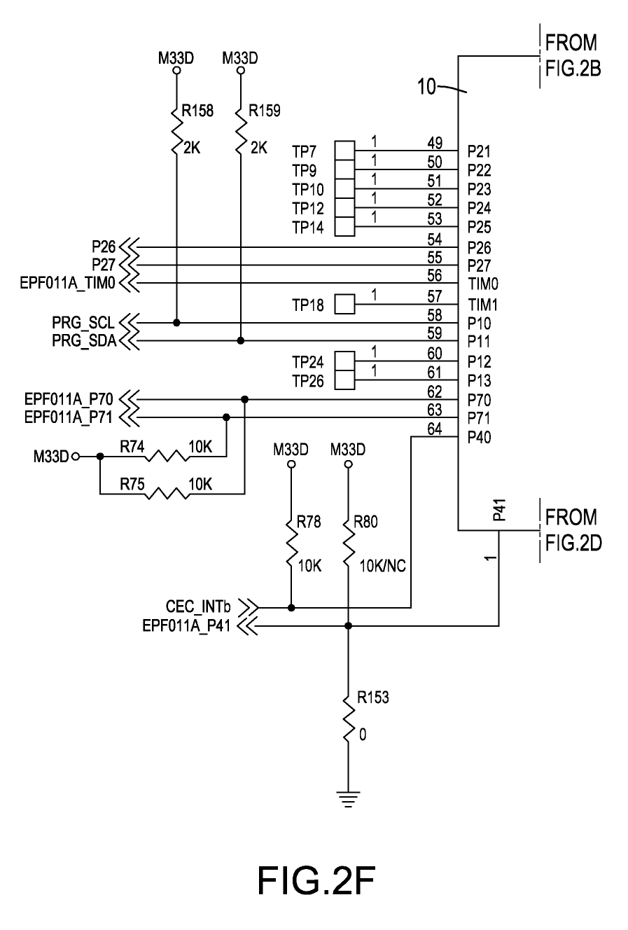

With reference to FIGS. 2A-2F, the detector 10 includes multiple duplex-connecting ports, multiple control pins and an extended display identification data (EDID) determining module. Preferably, one of the duplex-connecting ports has multiple pins P30 to P35 respectively connected to the display data channel (DDC) pin sets of the distributing unit 20, the first HDMI objective port 40 and the second HDMI objective port 50. Each DDC pin set is provided for transmitting an EDID signal to carry a resolution information of a monitor which is connected to the HDMI objective port.

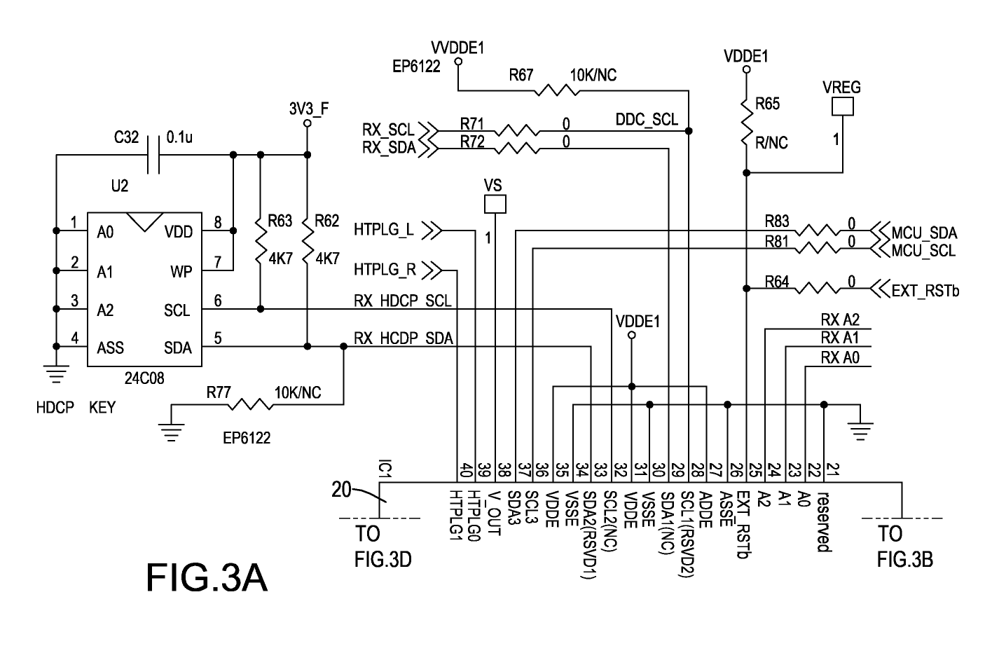

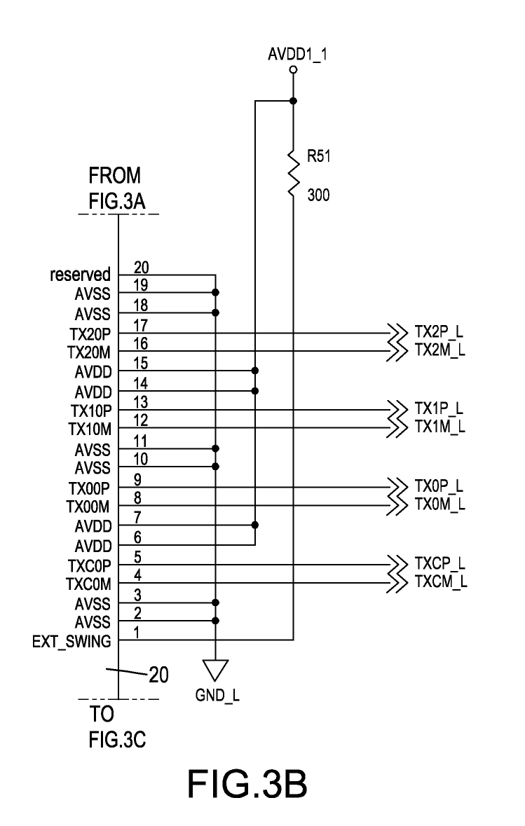

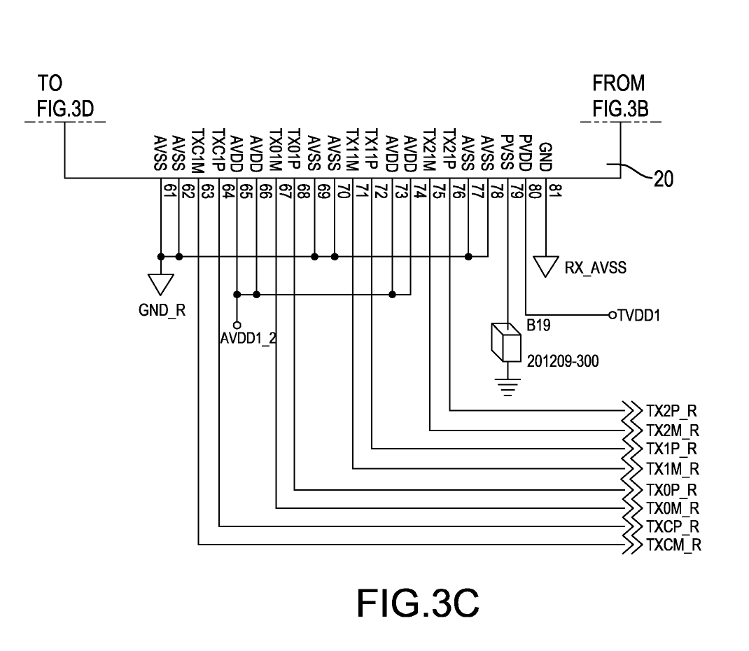

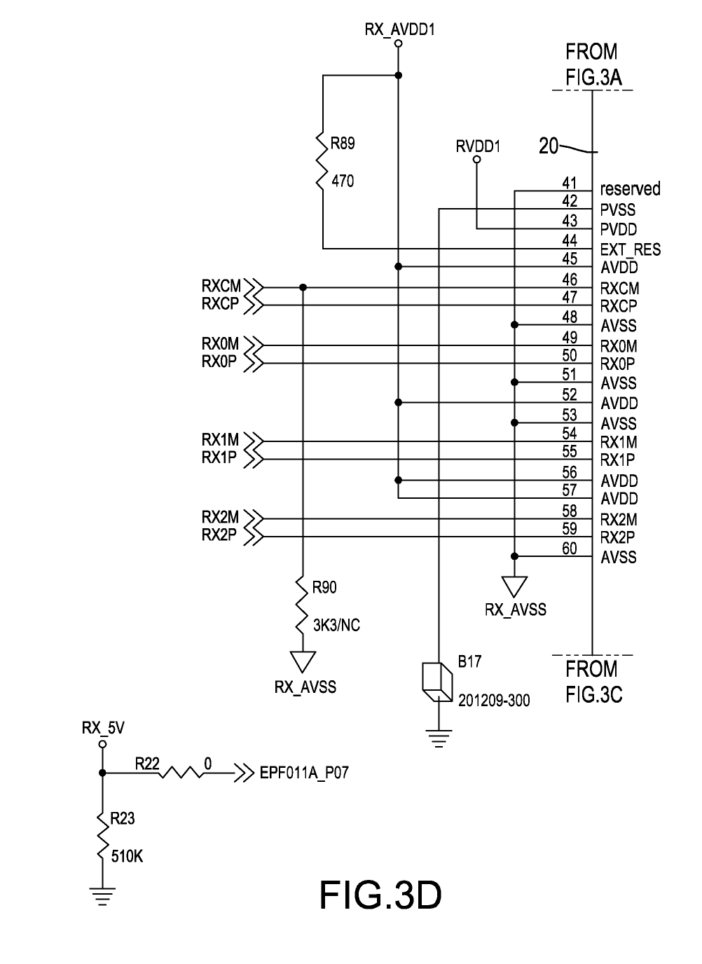

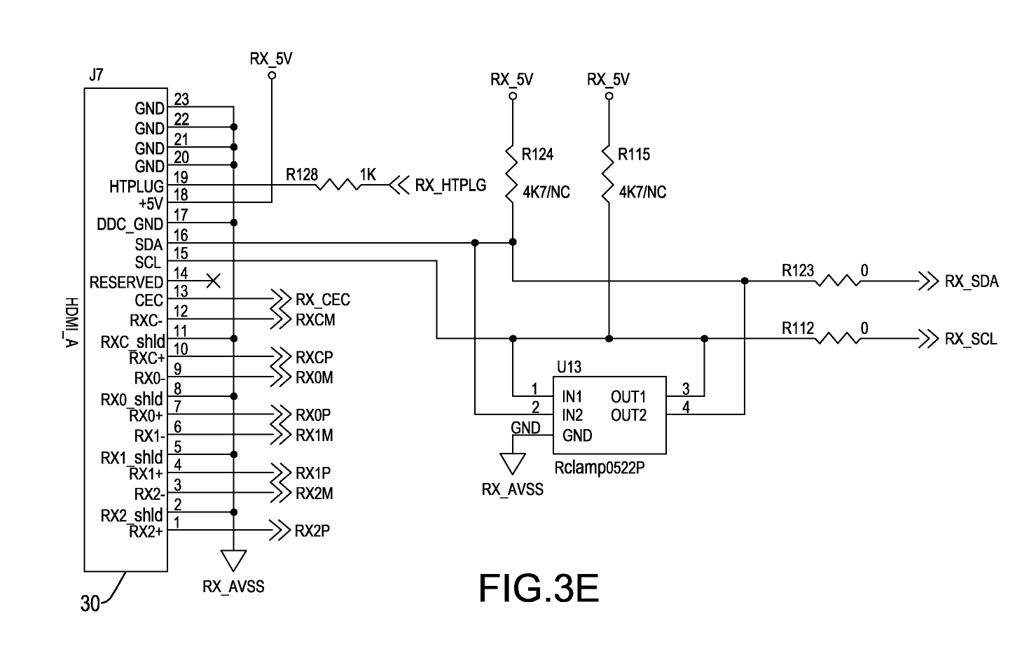

With reference to FIGS. 3A-3E, the distributing unit 20 includes an input port, multiple output ports, and multiple control pins. Preferably, the input port includes a data pin RXCM˜RX2P. The output ports include data pins TXCM_R˜TX2P_R and TECM_L˜TX2P_L. The control pins include MCU_SDA and MCU_SCL. The distributing unit 20 has two DDC pin sets. Each DDC pin set includes a serial clock input (SCL) pin and a serial data (SDA) pin. Preferably, the two DDC pin sets include an SCL1 pin, an SCL3 pin, an SDA1 pin and an SDA3 pin respectively connected to the pins P30 to P33 of the detector 10. The control pins of the distributing unit 20 are respectively connected to the control pins of the detector 10.

The HDMI source port 30 is a standard HDMI signal port and has a CEC pin, a hot plug detect (HTPLUG) pin, a DDC pin set and multiple data pins RXC−˜RX2+. The DDC pin set has an SCL pin and an SDA pin respectively connected to the DDC pin set of the input port of the distributing unit 20.

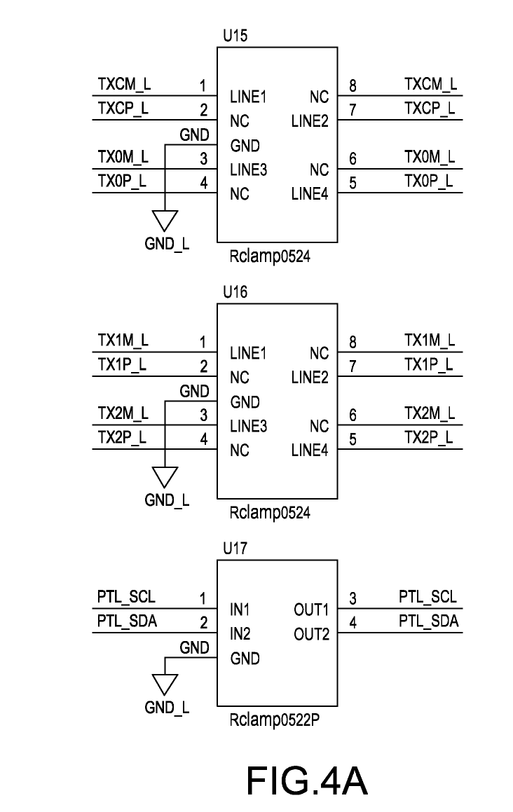

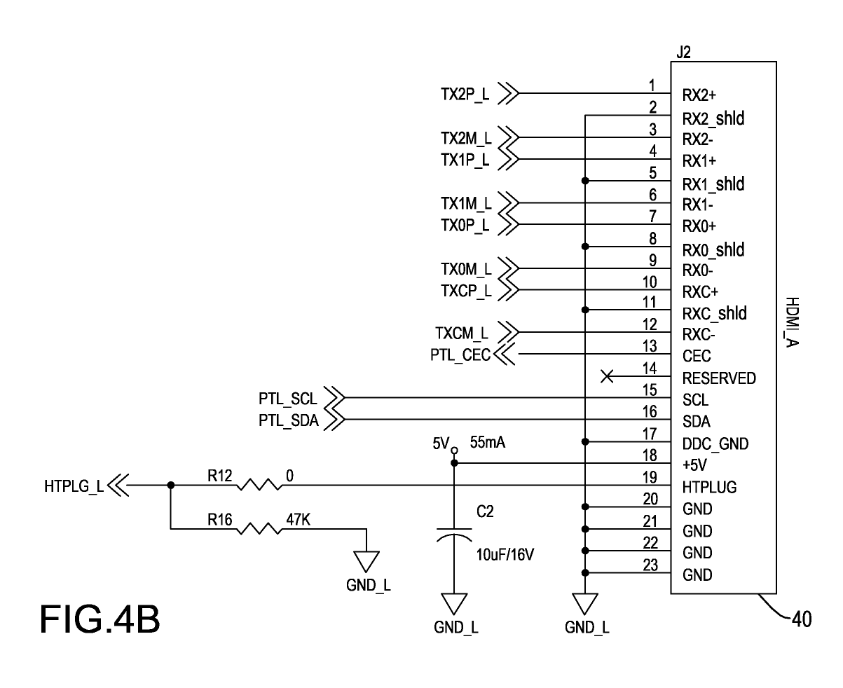

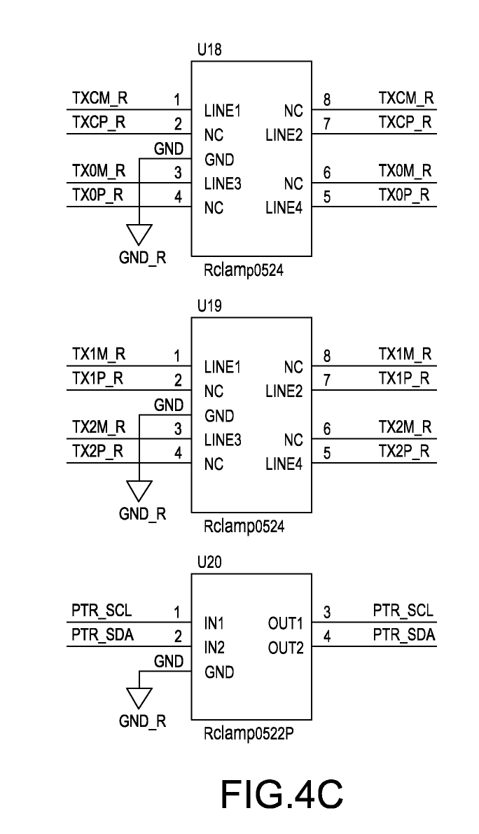

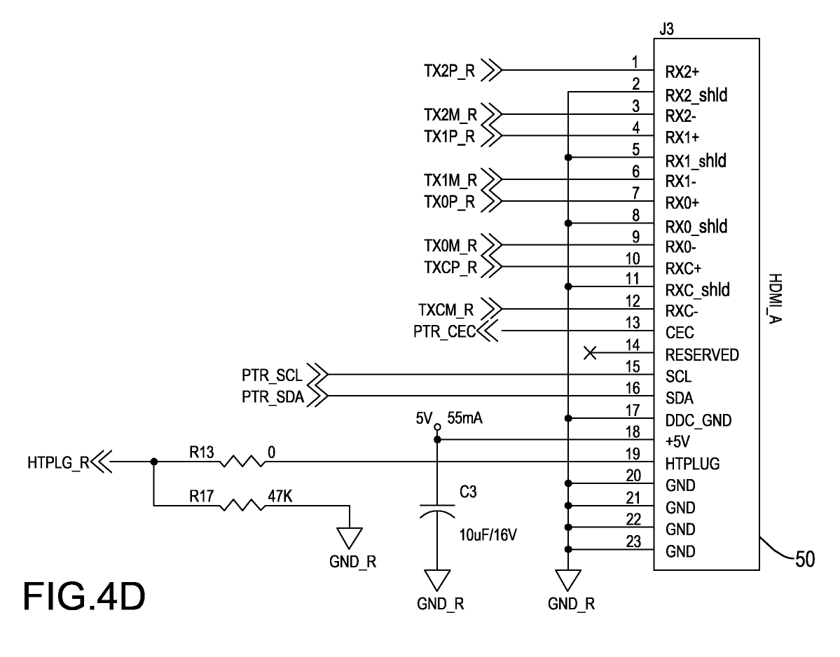

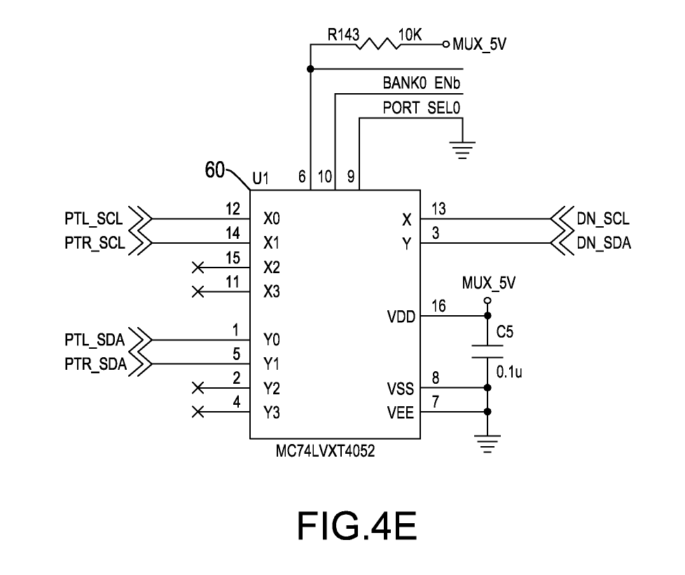

With reference to FIGS. 4A-4E, each of the first HDMI objective port 40 and the second HDMI objective port 50 has a DDC pin set and multiple data pins RXC−˜RX2+. The DDC pin set includes an SCL pin and an SDA pin. The first HDMI objective port 40 and the second HDMI objective port 50 are respectively connected to the output ports of the distributing unit 20. Preferably, the first HDMI objective port 40 and the second HDMI objective port 50 are connected to the detector 10 via a multiplexer/demultiplexer 60, such that the detector 10 is able to obtain EDID signals of the DDC pin sets of the first HDMI objective port 40 and the second HDMI objective port 50 from the multiplexer/demultiplexer 60.

When the first and second HDMI objective ports 40, 50 are respectively connected to two monitors, the detector 10 detects the EDID signals of the DDC pin sets of the first and second HDMI objective ports 40, 50 to determine which monitor has a highest displaying ability or a highest resolution information. The EDID determining module is controlled to force a signal source, which is connected to the HDMI source port 30, to send a video signal based on the highest displaying ability to the two monitors. The monitor, which has the highest displaying ability, is able to display the video signal.

Alternatively, the EDID determining module detects the EDID signals of the DDC pin sets of the first and second HDMI objective ports 40, 50 to determine which monitor has a lowest displaying ability. The EDID determining module is controlled to force the signal source to send video signals of the lowest displaying ability to the two monitors, such that all of the monitors can display video signals of the lowest displaying ability.

Based on the DEID signals of the HDMI objective ports and the HDMI source port, the EDID determining module is controlled to choose a mixed (MIX) mode or an efficiency gained with economy (ECO) mode.

The EDID determining module chooses a displaying ability from the EDID signal of a first one of the HDMI objective ports in the ECO mode and sends the control signal based on the displaying ability to the multiple HDMI objective ports. The EDID determining module chooses the lowest displaying ability from all of the EDID signals in the MIX mode and sends the control signal based on the lowest displaying ability to the multiple HDMI objective ports.

For instance, the monitor connected to the first HDMI objective port 40 accepts a signal of a higher resolution (i.e. 1080p resolution) while the monitor connected to the second HDMI objective port 50 accepts a signal of a lower resolution (i.e. 480p resolution). When the detector 10 in the MIX mode requests a lower resolution signal (480p) from the signal source, both of the two monitors connected to the first and second HDMI objective ports 40, 50 display video signals of the lower resolution. When the detector 10 in the ECO mode requests a higher resolution signal (1080p) to the signal source, the two monitors connected to the first and second HDMI objective ports 40, 50 respectively display video signals of the higher resolution. At least, the first HDMI objective port 40 is able to normally display the video signal of the higher resolution.

Therefore, the detector 10 detects the EDID signals from the DDC pin sets to request a suitable video signal from the signal source for preventing the monitors from incorrectly displaying while the first and second HDMI objective ports 40, 50 are respectively connected to the monitors of different resolutions.

Even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A high definition multimedia interface (HDMI) signal distributor comprising:
a distributing unit including:
an input port having a display data channel (DDC) pin set including a serial clock input (SCL) pin and a serial data (SDA) pin;
multiple output ports, each output port having a DDC pin set including an SCL pin and an SDA pin; and
multiple control pins;
an HDMI source port being capable of connecting to a signal source, connected to the distributing unit and including:
a DDC pin set including an SCL pin and an SDA pin; and
multiple data pins electrically connected to the input ports of the distributing unit;
multiple HDMI objective ports connected to the distributing unit, and each HDMI objective port being capable of connecting to a monitor and including:
a DDC pin set including an SCL pin and an SDA pin;
multiple data pins respectively and electrically connected to a corresponding one of the output ports of the distributing unit;
a detector connected to the distributing unit, the HDMI source port and the multiple HDMI objective ports, the detector including:
multiple duplex-connecting ports respectively and electrically connected to the DDC pin sets of the distributing unit, the HDMI source port and the HDMI objective ports;
multiple control pins respectively connected to the multiple control pins of the distributing unit; and
an extended display identification data (EDID) determining module comparing an EDID signal from each HDMI objective port with an EDID signal from the HDMI source port, the EDID determining module being controlled to choose a mixed (MIX) mode or an efficiency gained with economy (ECO) mode, the EDID determining module choosing a lowest displaying ability from all of the EDID signals in the MIX mode and sending the control signal based on the lowest displaying ability to the multiple HDMI objective ports, the EDID determining module choosing a displaying ability from the EDID signal of a first one of the multiple HDMI objective ports in the ECO mode and sending the control signal based on the displaying ability to the multiple HDMI objective ports.

2. The HDMI signal distributor as claimed in claim 1, wherein the multiple HDMI objective ports are connected to the detector via a multiplexer/demultiplexer, such that the DDC pin set of the detector obtains signals of the DDC pin set of the multiple HDMI objective ports from the multiplexer/demultiplexer.
